(19) United States
(12) Patent Application Publication
(10) Pub. No.: US 2015/0198147 A1
(43) Pub. Date: Jul. 16, 2015

(54) FUEL CELL INCORPORATING WIND POWER GENERATING DEVICE

(71) Applicant: National Tsing Hua University, Hsinchu (TW)

(72) Inventors: Che-Wun Hong, Hsinchu (TW); Hung-Hsiao Liu, Hsinchu (TW)

(73) Assignee: National Tsing Hua University, Hsinchu (TW)

(21) Appl. No.: 14/199,782

(22) Filed: Mar. 6, 2014

(30) Foreign Application Priority Data
Jan. 15, 2014 (TW) 103101523

(51) Int. Cl. F03D 9/00; H01M 8/04

(52) U.S. Cl. CPC F03D 9/002; H01M 8/04089

(57) ABSTRACT

A fuel cell incorporating a wind power generating device includes a fuel cell stack, a gas input unit and a wind power generating device. The gas input unit, configured to provide an input gas, includes a gas diffusion path and an inlet. The cell stack is connected to an end of the gas diffusion path. The inlet is disposed on another end of the gas diffusion path. The wind power generating device includes at least one first fan and a first electric generator. The at least one first fan is disposed in the gas diffusion path and is actuated by the input gas to drive the electric generator for generating electricity from wind power.

### CROSS-REFERENCE TO RELATED APPLICATIONS

The entire contents of Taiwan Patent Application No. 103101523, filed on Jan. 15, 2014, from which this application claims priority, are incorporated herein by reference.

### BACKGROUND OF THE INVENTION

1. Field of the Invention

The present invention generally relates to a fuel cell, and more particularly to a fuel cell incorporating a wind power generating device.

2. Description of Related Art

In recent years, as the energy shortage is growing and the environmental issues become more prominent, the fuel cell is widely expected as an environmentally friendly energy, which converts the chemical energy from a fuel (such as hydrogen) into electricity through a chemical reaction with oxygen or another oxidizing agent to produce electricity, so as to provide low-pollution energy.

FIG. 1A shows a cross-section view of a conventional fuel cell 100, and FIG. 1B shows the input gas flowing in the fuel cell 100. As shown in FIG. 1A/1B, the fuel cell 100 includes a cell stack 110, a gas input unit 120 and a gas output unit 130. The gas input unit 120 and the gas output unit 130 are respectively disposed at two ends of the cell stack 110.

When the fuel cell 100 is operating, the input gas would be introduced from the input port 124, then be transmitted to the cell stack 110 by a channel 122, and afterwards be output through the gas output unit 130. When being transmitted, the input gas would directly impact on an impact area 112 of the cell stack 110 and correspondingly generate separated-flows of the input gas, which then may flow into the cell stack 110 from the peripheral region of the impact area 112. Therefore, the input gas could not be uniformly and simultaneously flow into the fuel cell stack 110, so that the pressure between the input port and the output port of the cell stack 110 may be greatly reduced and the fuel cell 100 cannot be operated at the best overall efficiency. Further, as the energy transition rate of conventional fuel cell is quite low, therefore the fuel cell usually is used as substitute energy, and the utility of the fuel cell are limited as well.

A need has thus arisen to propose a novel fuel cell to overcome deficiencies of the conventional fuel cells and improve the energy transition rate and utilization rate.

### SUMMARY OF THE INVENTION

In view of the foregoing, it is an object of the embodiment of the present invention to provide a fuel cell for improving flow field uniformity and reducing gas pressure loss. The fuel cell with a configuration design of the baffle plate and perforated plate significantly improves the gas pressure loss and causes the input gas to uniformly flow into the cell stack for enhancing the overall efficiency.

According to one embodiment, a fuel cell incorporating wind generating device includes a cell stack, a gas input unit and a wind power generating device. The gas input unit is configured to provide an input gas. The gas input unit further includes a gas input passage and an input port. An end of the gas input passage is connected to the cell stack. The input port is disposed at another end of the gas input passage. The wind power generating device includes at least one first fan and at least one first generator. The first fan disposed in the gas input passage. When the fuel cell is in operation, the first fan is actuated by the input gas to drive the first generator for generating electricity from wind power simultaneously.

### BRIEF DESCRIPTION OF THE DRAWINGS

FIG. 1A shows a cross-sectional view of a conventional fuel cell;

FIG. 1B shows the input gas flowing in the fuel cell;

FIG. 2A shows a cross-sectional view of a fuel cell incorporating a wind power generating device according to one embodiment of the present invention;

FIG. 2B shows a side view of the wind power generating device of FIG. 2A;

FIG. 2C shows a side view of a wind power generating device according to another embodiment of the present invention;

FIG. 2D shows the input gas flowing in the fuel cell of FIG. 2A;

FIG. 2E shows a cross-section view of a fuel cell incorporating wind power generating device according to another embodiment of the present invention;

FIG. 2F shows the input gas flowing in the fuel cell of FIG. 2E.

FIG. 3A shows a cross-section view of a fuel cell according to one embodiment of the present invention; and

FIG. 3B shows a cross-section view of a fuel cell according to one embodiment of the present invention.

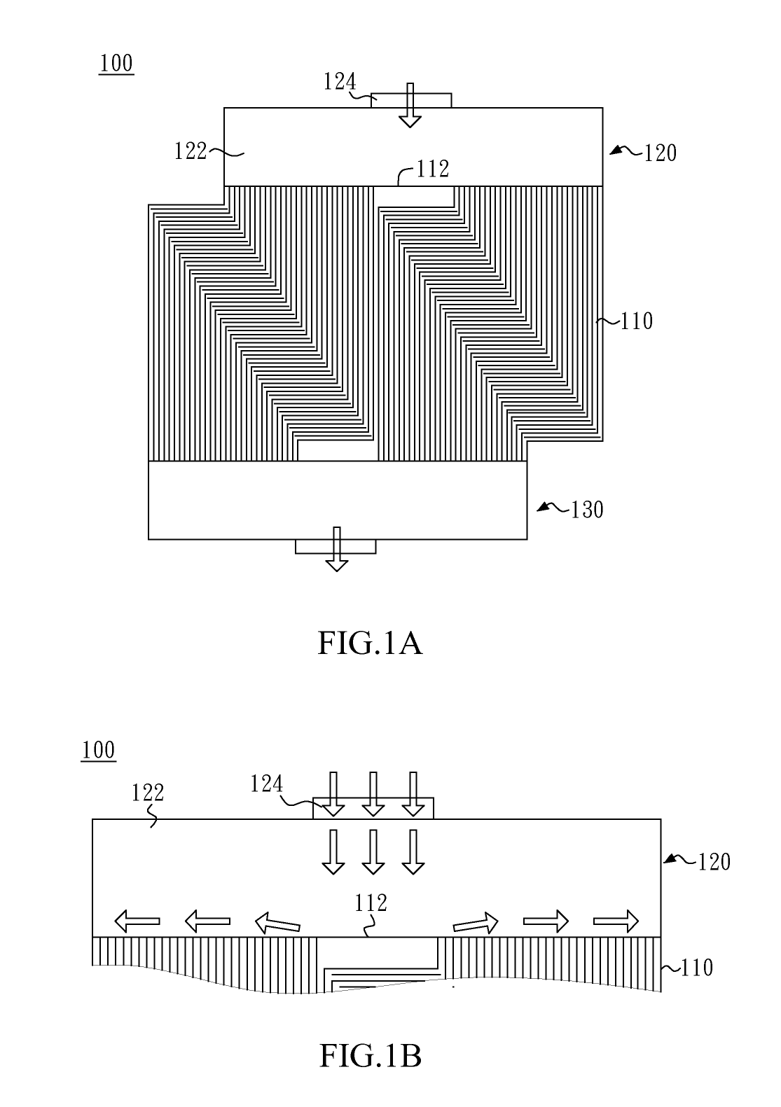

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

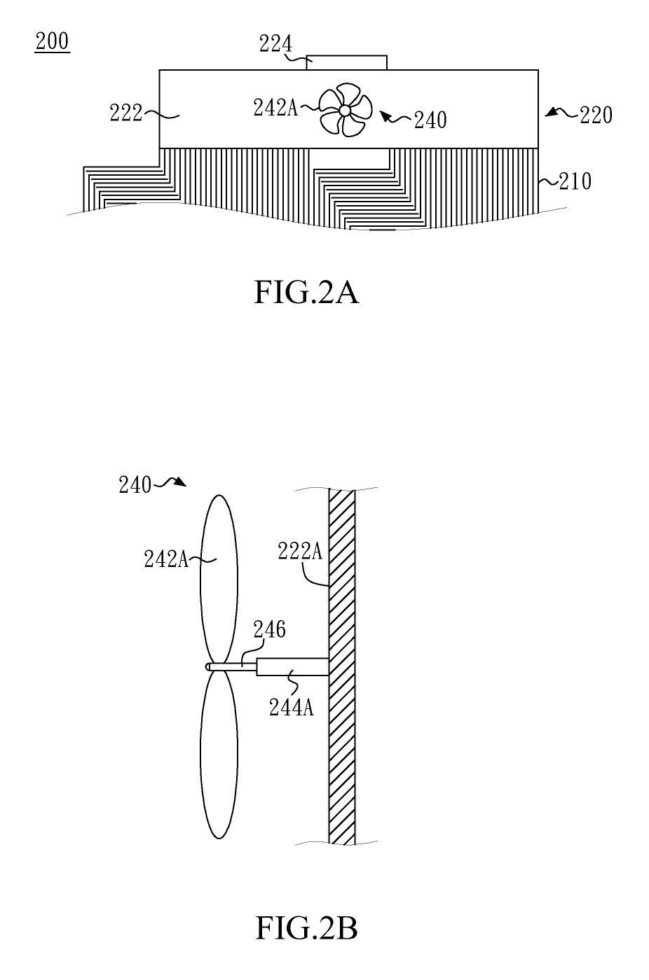

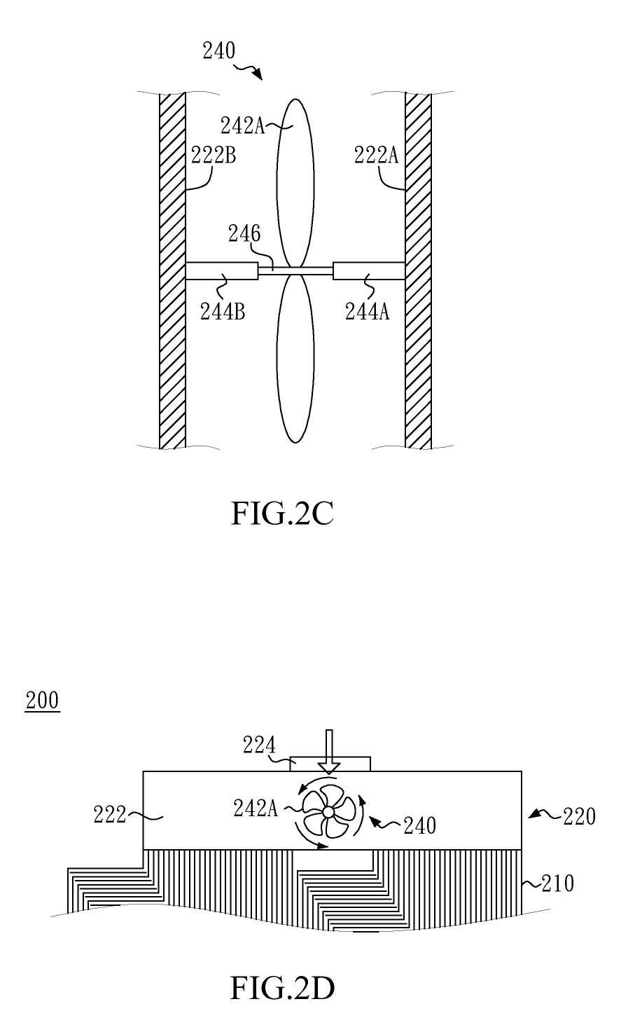

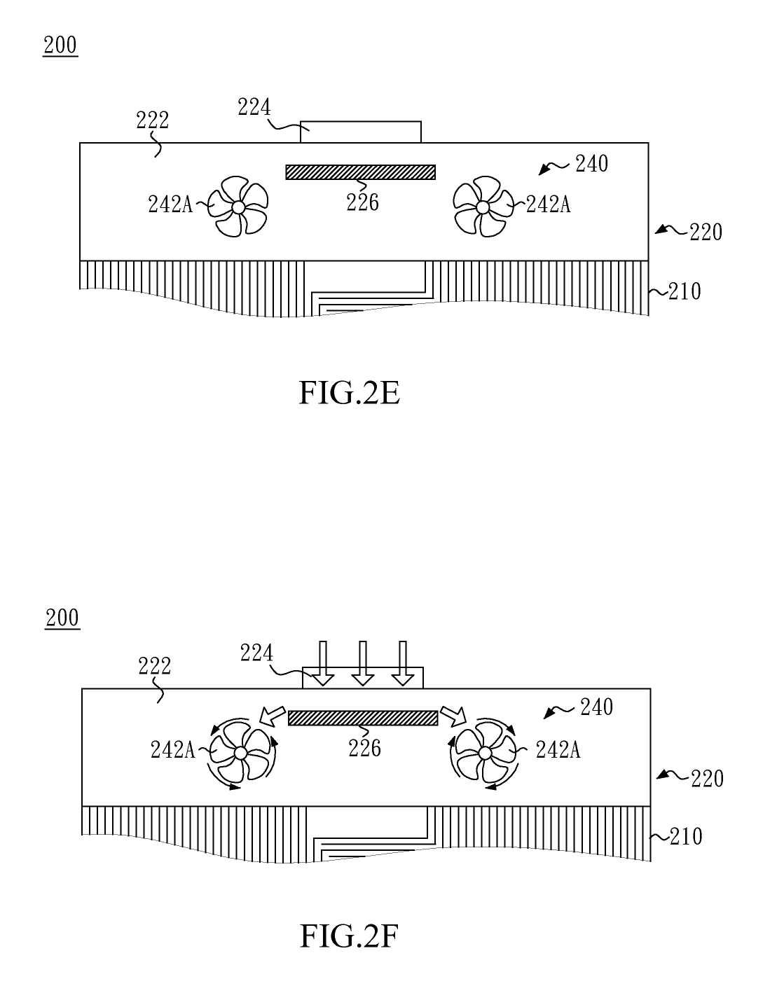

Referring to FIG. 2A/2B, FIG. 2A shows a cross-sectional view of a fuel cell incorporating a wind power generating device according to one embodiment of the present invention, and FIG. 2B shows a side view of the wind power generating device of FIG. 2A. The fuel cell 200 includes a cell stack 210, a gas input unit 220 and a wind power generating device 240. The gas input unit 220 is configured to provide an input gas. The gas input unit 220 includes a gas input passage 222 and an input port 224. An end of the gas input passage 222 is connected to the cell stack 210. The input port 224 is disposed at another end of the gas input passage 222. In the embodiment, a width of the gas input passage 222 is greater than an aperture diameter of the input port 224. The wind power generating device 240 includes at least one first fan 242A and at least one first generator 244A. The first fan 242A is disposed in the gas input passage 222. When the fuel cell is in operation, the first fan 242A is actuated by the input gas to drive the first generator 244A for generating electricity from wind power simultaneously.

As shown in FIG. 2B, in the embodiment, the first generator 244A is disposed on an inner side wall 222A of the gas input passage 222. Moreover, the wind power generating device 240 may further include a rotating shaft 246, configured to connect the first fan 242A and the first generator 244A. However, the present invention is not limited thereto. In another embodiment, the first generator 244A may be disposed on an external side of the gas input passage 222, in order to reduce the configuration space of the wind power generating device 240 in the gas input passage 222.

Referring to FIG. 2C, FIG. 2C shows a side view of a wind power generating device according to another embodiment of the present invention. The first fan 242A may be simultaneously connected to two first generators 244A and 244B by the rotating shaft 246, and the first generators 244A and 244B are correspondingly disposed on inner side walls 222A and 222B of the passage 222. Accordingly, the first fan 242A may be actuated by the input gas to drive the first generators 244A and 244B at the same time, so as to establish one-to-many configuration, which may efficiently transform wind power into electricity and substantially improve the energy transition rate.

Referring to FIG. 2D, FIG. 2D shows the input gas flowing in the fuel cell of FIG. 2A. The first fan 242A is disposed in front of the input port 224. Thus, after the input gas flows into the gas input passage 222 by the input port 224, the input gas may directly actuate the first fan 242A, so that the input gas may be prevented from directly impacting on the fuel cell stack 210 to greatly reduce the gas pressure loss.

Then, referring to FIG. 2E/2F, FIG. 2E shows a cross-section view of a fuel cell incorporating wind power generating device according to another embodiment of the present invention, and FIG. 2F shows the input gas flowing in the fuel cell of FIG. 2E. The fuel cell 200 further includes an input baffle plate 226. The input baffle plate 226 is disposed in the gas input passage 222 and located in front of the input port 224, and a gap exists between the input baffle plate 226 and the input port 224. Furthermore, a width of the input baffle plate 226 is greater than an aperture diameter of the input port 224.

Therefore, when an input gas is introduced into the gas input passage 222 by the input port 224, the input gas may completely and directly impact on the input baffle plate 226, and then generate separated flows of the input gas, which flow from the two sides of the input baffle plate 226 to diffuse into the cell stack 210, so as to prevent the input gas from directly impacting on the cell stack 210 and greatly reduce the gas pressure loss. In this embodiment, the input baffle plate 226 has a rectangular shape. However, the present invention is not limited thereto, so the shape of the input baffle plate 226 may be adjusted according to different needs of the actual design or the manufacturing process.

Moreover, as shown in FIG. 2E/2F, the first fans 242A are respectively disposed at two sides of the input baffle plate 226. Thus, the separated flows of the input gas, which is caused by the input baffle plate 226, may flow to the first fans 242A disposed at two sides of the input baffle plate 226, so that the first fan 242A may be actuated to generate kinetic energy, which may cause the rotating shaft 246 to drive the first generator 244A to generate the electric energy. After the input gas flows into the first fans 242A, the input gas will flow uniformly from the gas input passage 222 into the cell stack 210 for transforming the chemical energy into the electric energy, so as to create a hybrid energy system, which may improve the overall efficiency and power supply of the fuel cell 200.

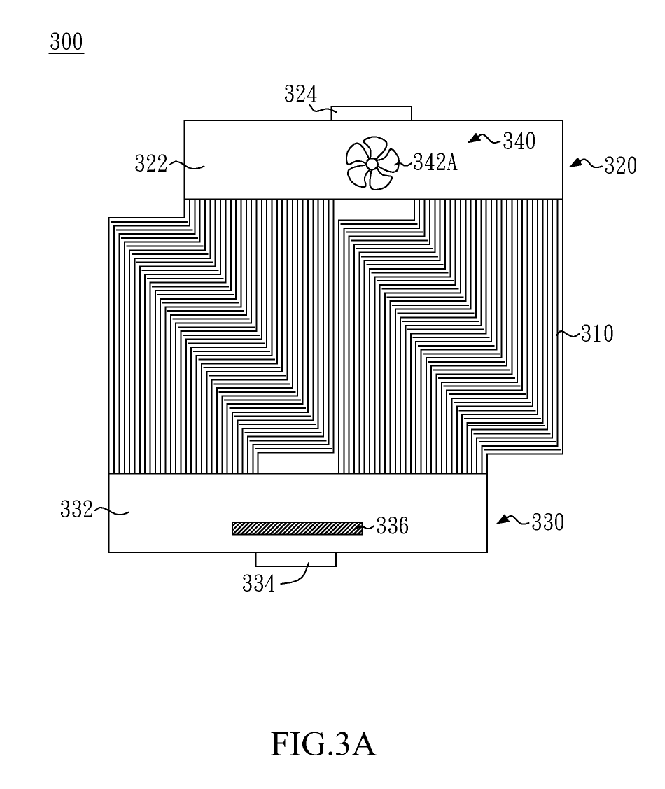

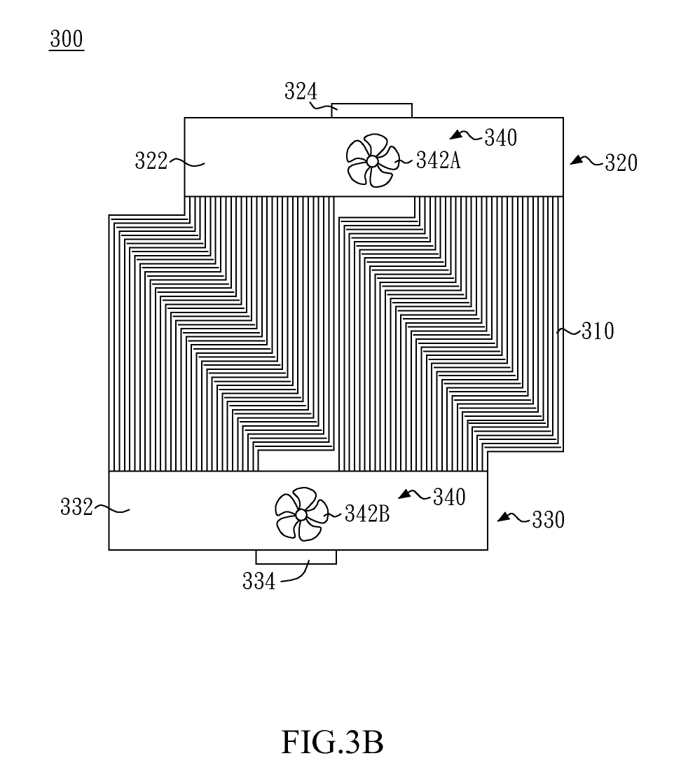

Referring to FIG. 3A/3B, FIG. 3A/3B respectively shows a cross-section view of a fuel cell 300 according to one embodiment of the present invention. The fuel cell 300 includes a cell stack 310, a gas input unit 320, a gas output unit 330 and a wind power generating device 340. The gas output unit 330 is disposed at another end of the cell stack 310. As shown in FIG. 3A, the gas output unit 330 includes a gas output passage 332, an output port 334 and an output baffle plate 336. An end of the gas output passage 332 is connected to another end of the cell stack 310. The output port 334 is disposed at another end of the gas output passage 332. The output baffle plate 336 is disposed in the gas output passage 332 and located in front of the output port 334, and a gap exists between the output baffle plate 336 and the output port 334. Therefore, when the output gas from the fuel cell stack 310 flows through the gas output passage 332 to the output port 334, as the output baffle plate 336 shields the output port 334 to reduce the practical aperture diameter and the output baffle plate 336 also causes the output gas to be separated to flow towards two sides of the gas output passage 332, the gas pressure of the gas output unit 330 can be greatly increased, so as to compensate the inner pressure loss of the fuel cell 300. Moreover, as the structure of the gas input unit 320 is so similar to the one in the embodiment mentioned above that the similarities are not repeated here.

In another embodiment, as shown in FIG. 3B, the wind power generating device 340 further includes at least one second fan 342B and at least one second generator 345. The second fan 342B is disposed in the gas output passage 332. When the fuel cell 300 is in operation, the second fan 342B can be actuated by an output gas, which flows from the cell stack 310, to drive the second generator 345 for generating electricity from wind power simultaneously. Furthermore, the second fan 342B may be connected with the at least one second generator 345 by the rotating shaft 346. As the structures of the second generator 345 and the rotating shaft 346 are so similar to the first generators 244A/244B and the rotating shaft 246 in the embodiment mentioned above that the similarities are not repeated here.

Furthermore, the second fan 342B is disposed in front of the output port 334. Thus, when the output gas flows from the cell stack 310 to the output port 334, the second fan 342B will be actuated to generate kinetic energy, and then the rotating shaft 346 may drive the second generator 345 to generate electricity correspondingly. Accordingly, when the fuel cell is in operation, it may provide electricity transformed from the wind power to significantly improve the energy transition rate by the input/output gas flowing in the fuel cell.

With the configuration of the fuel cell incorporating a wind power generating device mentioned in the above embodiments, it may not only greatly improve the electric generation efficiency of the conventional fuel cell, but also provide the wind power energy by the input gas flowing in the fuel cell and the wind power generating device having the simple configuration, to increase the energy transition rate and utilization rate of the fuel cell.

Although specific embodiments have been illustrated and described, it will be appreciated by those skilled in the art that various modifications may be made without departing from the scope of the present invention, which is intended to be limited solely by the appended claims.

What is claimed is:

1. A fuel cell incorporating a wind power generating, comprising:
a cell stack;
a gas input unit, configured to provide a input gas, wherein the gas input unit comprises:
a gas input passage, wherein an end of the gas input passage is connected to an end of the cell stack; and
an input port, disposed at another end of the gas input passage; and
a wind power generating device, comprising:
at least one first fan, disposed in the gas input passage; and
at least one first generator, wherein when the fuel cell is in operation, the at least one first fan is actuated by the input gas to drive the at least one first generator for generating electricity from wind power simultaneously.

2. The fuel cell of claim 1, wherein a width of the gas input passage is greater than an aperture diameter of the input port.

3. The fuel cell of claim 1, wherein the at least one generator is disposed on an inner side wall of the gas input passage.

4. The fuel cell of claim 1, wherein the at least one generator is disposed on an external side of the gas input passage.

5. The fuel cell of claim 1, wherein the at least one first fan is connected to the at least one generator by a rotating shaft.

6. The fuel cell of claim 1, wherein the at least one first fan is disposed in front of the input port.

7. The fuel cell of claim 1, wherein the gas input unit further comprises an input baffle plate, disposed in the gas input passage and located in front of the input port, wherein a gap exists between the input baffle plate and the input port.

8. The fuel cell of claim 7, wherein the at least one first fan disposed on two sides of the input baffle plate.

9. The fuel cell of claim 7, wherein a width of the input baffle plate is greater than an aperture diameter of the input port.

10. The fuel cell of claim 7, wherein the input baffle plate has a rectangular shape.

11. A fuel cell incorporating a wind power generating device, comprising:
a cell stack;
a gas input unit, configured to provide an input gas, wherein the gas input unit comprises:
a gas input passage, wherein an end of the gas input passage is connected to the cell stack; and
an input port, disposed at another end of the gas input passage;
a gas output unit, disposed in the another end of the cell stack, wherein the gas output unit comprises:
a gas output passage, wherein an end of the gas output passage is connected to another end of the cell stack; and
an output port, disposed at another end of the gas output passage; and
a wind power generating device, comprising:
at least one first fan, disposed in the gas input passage; and
at least one first generator, wherein when the fuel cell is in operation, the at least one first fan is actuated by the input gas to drive the at least one first generator for generating electricity from wind power simultaneously.

12. The fuel cell of claim 11, wherein the gas output unit further comprises an output baffle plate, disposed in the gas output passage and located in front of the output port, wherein a gap exists between the output baffle plate and the output port.

13. The fuel cell of claim 12, wherein a width of the output baffle plate is greater than an aperture diameter of the output port.

14. The fuel cell of claim 12, wherein at least one end of the output baffle plate is connected to a side wall of the gas output passage.

15. The fuel cell of claim 11, wherein the wind power generating device further comprises:
at least one second fan, disposed in the gas output passage; and
at least one second generator, wherein when fuel cell is in operation, the at least one second fan is actuated by an output gas, which flows from the cell stack, to drive the second generator for generating electricity from wind power simultaneously.

16. The fuel cell of claim 15, wherein the at least one second fan is disposed in front of the output port.

17. The fuel cell of claim 11, wherein the at least one second fan is connected to the at least one second generator by a rotating shaft.
